(19) United States
(12) Patent Application Publication
(10) Pub. No.: US 2014/0067486 A1
(43) Pub. Date: Mar. 6, 2014

(54) SYSTEMS, METHODS, AND COMPUTER PROGRAM PRODUCTS FOR PRIORITIZING INFORMATION

(71) Applicants: Marcos Dias De Assuncao, Sao Paulo (BR); Silvia Cristina Sardela Bianchi, Sao Paulo (BR); Marco Aurelio Stelmar Netto, Sao Paulo (BR)

(72) Inventors: Marcos Dias De Assuncao, Sao Paulo (BR); Silvia Cristina Sardela Bianchi, Sao Paulo (BR); Marco Aurelio Stelmar Netto, Sao Paulo (BR)

(73) Assignee: International Business Machines Corporation, Sao Paulo (BR)

(21) Appl. No.: 13/598,327

(22) Filed: Aug. 29, 2012

(51) Int. Cl. G06Q 99/00

(52) U.S. Cl. 705/12

(57) ABSTRACT

A method of prioritizing information, the method includes receiving report information of an event, the report information including geographical identifying information of a reporting entity, one of receiving or determining vote information in response to the report information, and prioritizing the event according to the report information and the vote information, as performed by a processor in a computer system.

### BACKGROUND OF THE INVENTION

1. Field of the Invention

The present invention generally relates to systems, methods, and computer program products for prioritizing information, and more particularly to systems, methods, and computer program products for prioritizing information based on a consensus technique.

2. Description of the Related Art

Providing continuous operation of city services and simulation engines is important to ensure the well-being of a population and is becoming an essential building block of smarter cities. Due to the increasing frequency of adverse weather events and natural disasters, cities often have to cope with emergency situations during which certain areas may experience difficult road conditions, bad network connectivity, or may be rendered completely inaccessible.

Accordingly, operation centers that are able to handle incidents and emergency situations have become crucial in dealing with such adverse conditions. These centers often include at least an IT infrastructure and a team of agents.

The IT infrastructure is responsible for collecting and processing information from a range of city services and simulation engines (e.g. police, fire departments, traffic management systems, weather forecasts, and flooding simulation). The team of agents, on the other hand, is responsible for activities, such as analyzing potential emergency situations, planning for emergencies, and deploying personnel in the field to minimize the impact of a disaster.

In some situations, there is a recurrent solution of gathering and displaying information about affected areas and populations. The recurrent solution consists of using social network systems and crowd-sourcing platforms.

These systems and platforms receive information about impacted areas and people. This information generally includes pictures of damaged infrastructure, messages about wounded people, blocked streets, among other facts. The information is often plotted on a map and viewed by operation center personnel who are responsible for planning for a response to the situation.

The main challenges for using such platforms in emergency operation centers are (i) to display large amounts of information, (ii) to consolidate and disregard duplicated information, and (iii) to identify the degree of accuracy and trust of the reported information. Addressing such challenges is important for establishing priorities, coordinating efforts and deploying resources in the affected areas.

The present inventors have recognized that conventional technologies only allow authorized users (e.g., emergency operations center workers) to change attributes of maps. Accordingly, not only is it very difficult for the authorized users to display the large amount of information, but also it is very difficult for these authorized users to consolidate and disregard the duplicated information. On top of these very difficult tasks, the authorized user must also perform the extremely difficult task of identifying the degree of accuracy and trust of the reported information.

As can be imagined, in some situations, such as, for example, a disaster, the amount of information being received by the operation center is extremely large. As a result, in some situations, the task of establishing priorities, coordinating efforts and deploying resources in a highly efficient manner is extremely difficult. Due to the high level of difficulty, affected areas and populations either fail to receive any aid or receive aid in a very delayed fashion. Due to the time sensitive nature of some emergency responses, this delay or failure to respond can have catastrophic consequences.

Having recognized this recurring problem in disaster relief efforts, the present inventors realized that conventional technologies do not support crowd-sourcing efforts in order to change how the information is handled and ranked.

Furthermore, they have recognized that not only do conventional technologies not rank the point-of-interest information, but also no conventional technologies consider the importance that the geolocation of a reporting entity can play under emergency.

Accordingly, the present inventors have recognized a need for a system, method, and computer program product, which prioritizes information based on a consensus technique.

### SUMMARY OF THE INVENTION

In view of the foregoing and other exemplary problems, drawbacks, and disadvantages of the conventional methods and structures, an exemplary feature of the present invention is to provide systems, methods, and computer program products in which crowd-sourcing efforts can be used in order to change how information is prioritized based information relating to the entities being crowdsourced.

Another exemplary feature of the present invention is to rank incidents using information, such as, for example, geolocation tags, reputation and importance.

A first exemplary aspect of the present invention includes a method of prioritizing information, the method comprising: receiving report information of an event, the report information including geographical identifying information of a reporting entity; one of receiving or determining vote information in response to the report information; and prioritizing the event according to the report information and the vote information, as performed by a processor in a computer system.

Another exemplary aspect of present invention includes a method of prioritizing an event, the method comprising: receiving a report of the event from a reporting entity, the report including geographical information of the reporting entity and information relating to the event; determining a certain number of votes needed to change an initial priority of the event according to the report, the determining being performed by a processor in a computer system; and changing the initial priority of the event, if the certain number of votes is received.

Another exemplary aspect of the present invention includes a method of prioritizing a response to an event, the method comprising: receiving a report regarding the event; determining a value of a vote for the report that is associated with the event; and prioritizing, as performed by a processor in a computer system, the response to the event, based on values calculated for each parameter of a plurality of tuple parameters, the tuple parameters including at least one of: a distance between a reported location of the event and a location of an entity that reports the event; and a distance between the reported location of the event and a location of an entity that transmits the vote associated with the event.

Another exemplary aspect of the present invention includes a method of prioritizing a plurality of events, the method comprising: gathering information relating to each event of the plurality of events; determining crowdsourced information relating to each event, the crowdsourced information of each event including vote information associated with each voting entity of a plurality of voting entities, the vote information of each voting entity including at least one of: a first geolocation value, which is based on comparing a reported location of the event and a location of a voting entity having generated the vote information; and a first reputation value associated with the voting entity having generated the vote information; and determining, as performed by a processor in a computer system, an order in which to respond to the plurality of vents according to a plurality of factors including tunic information expressing at least one of the first geolocation value and the first reputation value.

Another exemplary aspect of the present invention includes a computer program product tangibility embodying a program of machine-readable instructions executable by a digital processing apparatus to perform an event prioritization method, the method comprising: determining geographical identifying information of a reporting entity having transmitted report information of an event; aggregating vote information associated with the report information; and prioritizing the event according to a plurality of factors including: the report information; the vote information; and the geographical identifying information of the reporting entity.

Another exemplary aspect of the present invention includes a system that prioritizes information, the system comprising: an input that receives at least one of: report information of an event, the report information including geographical identifying information of a reporting entity; and vote information associated with the report information a memory device that stores instructions; and a processor that executes the instructions stored in the memory device to prioritize the event according to the report information and the vote information.

Another exemplary aspect of the present invention includes a system comprising: a memory device that stores instructions to prioritize an event; an input that receives a report of the event, the report including geographical information of a reporting entity and information relating to the event; and a processor that executes the instructions stored in the memory device. The instructions cause the processor to: determine a number of votes needed in order to change a priority of the event according to the report; and change the priority of the event if the number of votes is received.

Another exemplary aspect of the present invention includes a system comprising: a memory device that stores instructions to prioritize an event; an input port that receives at least one of a report regarding the event and a vote associated the event; and a processor that executes the instructions stored in the memory device to prioritize the response to the event according to parameter values of a plurality of tunic parameters including: a value representing a distance between a reported location of the event and a location of an entity that reported the event; and a value representing a distance between the reported location of the event and a location of an entity that transmitted the vote associated with the event.

Another exemplary aspect of the present invention includes a system comprising: a memory device that stores a plurality of information to prioritize an invent, the information including: report information of each event of the plurality of events; crowdsourced information associated with each event, the crowd-sourced information of each event includes vote information associated with each voting entity of a plurality of voting entities, the vote information of each voting entity includes at least one of: a first geolocation value that is based on a comparison between a reported location of the event and a location of a voting entity that generates the vote information; and a first reputation value that is associated with a voting entity that generates vote information; and a processor that determines an order in which to respond to the plurality of events according to a plurality of factors including tuple information expressing the first geolocation value and the first reputation value.

Another exemplary aspect of the present invention includes a computer program product for prioritizing information, the computer program product including a computer readable storage medium that stores program instructions, the program instructions including: first program instructions to determine geographical identifying information of a reporting entity having transmitted report information of an event; second program instructions to aggregate vote information associated with the report information; and third program instructions to prioritize the event according to a plurality of factors including: the report information; the vote information; and the geographical identifying information of the reporting entity.

With its unique and novel features, the exemplary aspects of the present invention may provide a system, method, and computer program product, which ranks information in order to prioritize responses and to speed the resolution of a problem.

Furthermore, exemplary aspects of unique and novel features of the present invention may provide a system, method, and computer program product, which optimizes the deployment of personnel in order to more efficiently and quickly respond to an incident.

Even more, exemplary aspects of unique and novel features of the present invention may provide a system, method, and computer program product, which determines what services and infrastructure should be tended to first in order to address the issues of the population.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1A depicts an exemplary system considered by the present invention;

FIG. 1B depicts an exemplary embodiment of the present disclosure;

FIG. 2 depicts an exemplary embodiment of the present disclosure;

FIG. 3 depicts another exemplary embodiment of the present disclosure;

FIG. 4 depicts a detailed description of a system block diagram of an exemplary embodiment of FIG. 3;

FIG. 5 depicts a detailed description of a system block diagram of an exemplary embodiment of FIG. 3;

FIG. 6 depicts a detailed description of a system block diagram of an exemplary embodiment of FIG. 3;

FIG. 7 depicts a detailed description of a system block diagram of exemplary embodiments of FIGS. 2 and 3;

FIG. 8 depicts a detailed description of a system block diagram of exemplary embodiments of FIGS. 2 and 3;

FIG. 9 is a typical hardware configuration which may be used for implementing the inventive aspects of the present disclosure; and

FIG. 10 is a description of exemplary storage media which may be used in conjunction with the typical hardware configuration of FIG. 9.

### DETAILED DESCRIPTION OF EXEMPLARY EMBODIMENTS OF THE INVENTION

The following detailed description describes various features and functions of the disclosed systems, methods and computer program products with reference to the accompanying figures. In the figures, similar systems typically identify similar components, unless context dictates otherwise. The illustrative system, method and computer program product are not meant to be limiting. It will be readily understood that certain aspects of the disclosed systems, methods and computer program products can be arranged and combined in a wide variety of different configurations, all of which are contemplated herein.

Some exemplary aspects of the exemplary embodiments of the present disclosure include ranking information under emergencies in order to prioritize problem resolution, optimizing the deployment of personnel in disaster relief for faster incident handling, and determining the order in which services and infrastructure should be restored in order to address the issues of the population.

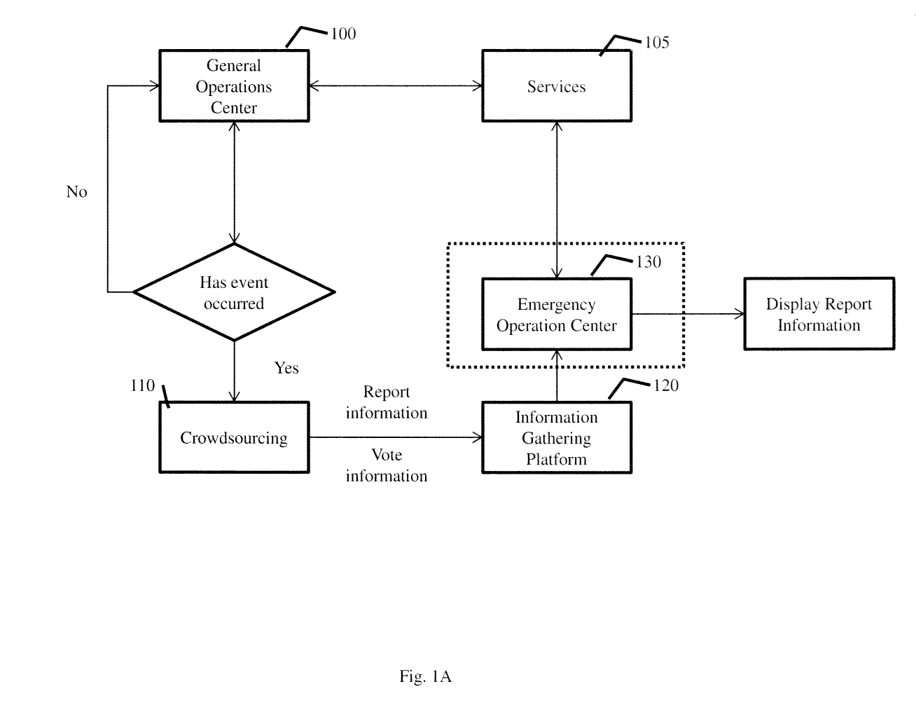

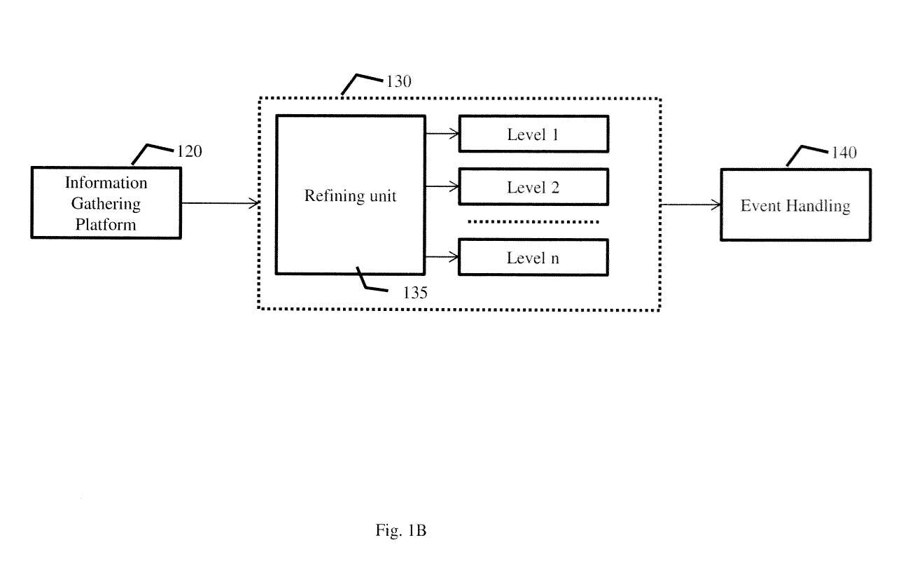

As a preliminary introduction for the following description of the present invention, FIG. 1A depicts an exemplary flowchart of an overall system and scenarios considered by the present invention. A General Operations Center 100 monitors the status of services 105 (e.g., local or city services and performs simulations on various conditions of a managed infrastructure. If an event occurs, (e.g., a weather event, traffic conditions, utility outage, a disaster, an emergency, etc.), then one or more crowdsourced entities 110 can report information regarding the conditions of, for example, the local services, the infrastructure, the affected people/person, etc., to an Information Gathering Platform 120. This information may be referred to herein as “report information.” A crowdsourced entity that reports the information may be referred to herein as a “reporting entity.” A crowdsourced entity that votes for the prioritization of the event may be referred to herein as “a voting entity”. Vote information is received from the voting entities.

In some exemplary embodiments, the Information Gathering Platform 120 includes a crowd mapping system such as, for example, OpenStreetMap™, Ushahidi™, Sahana™, CrisisMappers™ and Google™ MapMaker™, etc.

The Information Gathering Platform 120 passes the information to an Emergency Operations Center 130. The Emergency Operation Center 130 refines, prioritizes, and displays the report information using, for example, map driven visualization techniques.

Based on the information, the Emergency Operations Center 130 plans an effective utilization of resources, deploys assistance personnel in a prioritized fashion, tunes simulation models, adjusts the manner and the order in which any one or more of: services are provided, infrastructure is secured, affected people are addressed or treated, etc.

In some exemplary embodiments of the present disclosure, a consensus technique is used in order to prioritize events based on geolocation tags, reputation, and importance under of the event in order to prioritize a solution of problems with higher impact.

FIG. 1B depicts some exemplary embodiments of the present disclosure. The Emergency Operations Center 130 receives the report information collected using the Information Gathering Platform 120. The reporting entity may gather the report information through any one or more of a sensor, a camera, a text message, and a report of, for example, damaged areas, compromised infrastructure, blocked streets, and injured people, among other aspects.

In order to achieve coordinated control and efficient decision making, the report information is refined in a refining unit 135 (e.g., sorted, prioritized, streamlined to remove duplicate reports, etc.). In some exemplary embodiments, the refining unit is a server on a network. This feature is especially beneficial when a large amount of data is reported in a short period of time.

In this way, events can be assigned to categories (e.g. levels 1 . . . , n) with different degrees of urgency or priority. The events may be responded to/handled 140 based on their priority level.

For example, in an exemplary embodiment with three categorization levels, there may be three prioritization levels “urgent” “normal” and “relaxed” assigned to levels 1, 2 and 3, respectively. Of course the prioritization levels would be responded to in the aforementioned order.

The prioritization of the event may be based on a quorum consensus algorithm. According to the quorum consensus algorithm, for each event having been reported, a minimum number of votes, which are needed to change the priority of the event, are assigned to the event. Once a number of votes received is greater than or equal to the minimum number of votes assigned to each event, then the priority (e.g., the categorization level) of the event is changed.

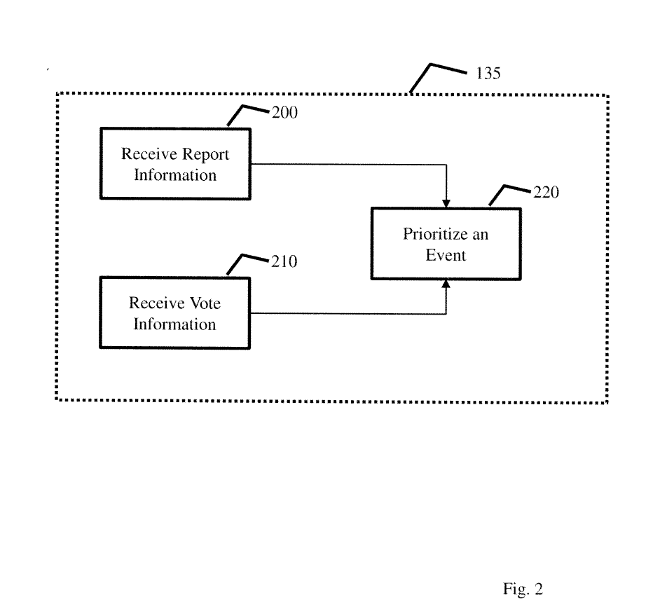

FIG. 2 is a system block diagram that may be used to prioritize information of events. Specifically, report information 200 of an event is received from a reporting entity. The report information includes geographical identifying information of the reporting entity. Vote information 210 is received in response to the report information. The event is prioritized 220 based on the report information 200 and the vote information 210.

In some exemplary embodiments, the respective features of the system block diagram of FIG. 2 are implemented by any one or more of a terminal, a circuit, a module, a processor on a computer system, a memory device, etc.

The present inventors have determined that if a reporting entity reports an event in an area to which the reporting entity is closely located, then the likelihood that the reported information is accurate is increased. Similarly, the present inventors have recognized that the more distant from the event that the reporting entity is, then the higher the probability that the report information is inaccurate.

The geographical identifying information, as achieved, for example using location information as data associated with event reports, makes the location of the reporting entity determinable. For example, the geolocation of the reporting entity may be determined with the aid of, e.g., GPS, cell phone triangulation, Wi-Fi hotspots, a description of the location of the reporting entity, etc.

In some exemplary embodiments, the geographical identifying information may include geotagged information. For example, it may include a geographical identification tag or metadata indicating the location of the reporting entity. In addition, the geographical identification information may include latitude and longitude coordinates of the reporting entity. Furthermore, in some exemplary embodiments, the geographical identifying information includes any one or more of altitude, bearing, distance, accuracy data, and place names.

In other exemplary embodiments, the geographical identifying information includes geocoded information of the location of the reporting entity. For example, if the reporting entity reports their location in a format such as, e.g., a street address, a mile marker, a zip code, etc., then a geocoder may be used to determine the associated geographic coordinates from the street address or zip code. As will be appreciated by one having ordinary skill in the art, any other geographic data may be used in order to determine the geographic coordinates of the reporting entity, as long as it is possible to a geographical location of the reporting entity.

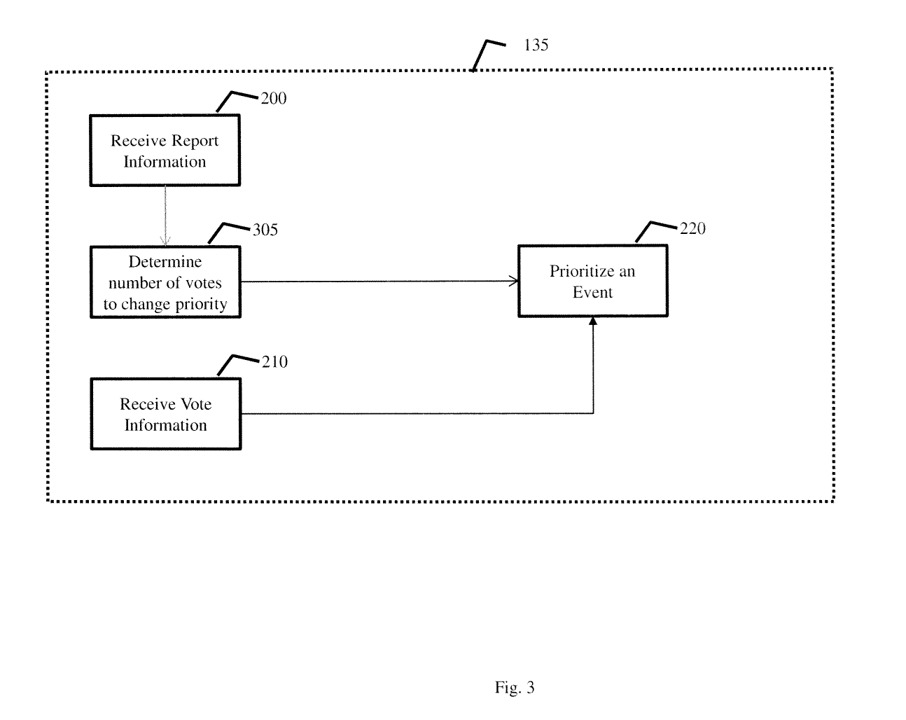

FIG. 3 is a system block diagram of another exemplary embodiment, which may be used to prioritize information of events, according to the present disclosure. Like parts to those discussed above are designated with like reference numbers, and therefore a duplicative discussion will not be provided. In this exemplary embodiment, a minimum number of votes 305, which are needed in order to change a priority of the event, is determined. The minimum number of votes 305 that are needed is determined based on information about the entity that reported the event and information about the event itself. The event is prioritized 220 in accordance with a number of votes received 210 from voting entities and the minimum number of votes 305 that are determined to be needed in order to change a priority of the event.

A vote can be considered as a way for a voting entity to express whether an event is important or not.

In addition to the importance that the geographical location of the reporting entity may play, the present inventors have also recognized that a reputation of the reporting entity (which can be based on previous event reports) can be important to determining the minimum number of votes needed to change the priority of the event.

For example, if a specific reporting entity has a history of accurately reporting the importance of an event, then it is more likely that the specific reporting entity will report an accurate importance of the event.

On the other hand, if a specific reporting entity has a history of inaccurately reporting the importance of events, then it is more likely that the specific reporting entity may inaccurately report the importance of the event. Accordingly, the report information of any of the exemplary embodiments discussed herein may also include (or be used to determine) reputation information of the reporting entity.

Votes may also be used to score a reputation of the reporting entity, as well as a reputation of the voting entity. For example, if the reporting entity has a history of classifying reported events in a manner in which voting entities concur, then a reputation of the reporting entity may be considered to be higher than if the reporting entity has a history of classifying events in a manner in which voting entities generally disagree.

Similarly, if a voting entity has a history of voting in a manner in which other voting entities concur, then a reputation of the voting entity may be considered to be higher than if the voting entity has a history of voting in a manner in which other voting entities generally disagree.

The reputation information of the reporting entity may be calculated based on the contribution of the reporting entity when reporting other incidents. For example, in some exemplary embodiments, every reporting entity starts with a reputation score of zero. That is, if a reporting entity has not previously contributed, then they have a reputation score of zero. As the reporting entity reports on events, then the reputation score may be modified according to votes that the reporting entity receives over time.

For example, if the reporting entity receives concurring votes on events that they report, then their reputation score will increase. On the other hand, if the reporting entity receives disagreeing votes for events that they report, then their reputation score will decrease. The reputation score of the reporting entity therefore increases or decreases according to the number of concurring votes or contradicting votes attributed to previous events that were reported by the reporting entity. As a result, a reporting entity, which is considered to be highly reliable, will be given a higher reputation score, than a new reporting entity or a reporting entity, which is considered to be highly unreliable.

In some exemplary embodiments, the reputation information of a specific reporting entity is associated with the reporting entity based on at least one of: a telephone number, an email address, a username, etc. Likewise, in some exemplary embodiments, a reporting entity can register one of the aforementioned means of association. During the registration process, information can be associated with the reporting entity. For example, an occupational profession may be associated with the reporting entity. Based on this information, a starting reputational score of the reporting entity can be adjusted to have a starting value other than zero.

For example, a reporting entity may receive a higher starting reputation score on the basis of their profession. As a non-limiting example, police officers, members of the military, firefighters, members of FEMA, or members of first response teams may receive a higher starting reputation scores. This feature may allow certain events to receive a higher prioritization with fewer votes, if they are reported by members who typically respond to emergency type situations.

In some exemplary embodiments, if a reporting entity with either or both of: a high reputation; and a location that is at or near (e.g., within a predetermined threshold distance) the event, then the number of votes necessary to validate the event and change the prioritization of the event is less than if the reporting entity has either or both of: a low reputation; and a location that is not near the event.

The present inventors have also recognized that a reporting entity is more likely to be truthful than not if they are reporting a severe event. Accordingly, the report information may also include a description of the event reported by the reporting entity.

Based on the description of the event report, an exemplary embodiment of the claimed invention calculates the importance value for the event. For example, reporting of a wounded person may have a higher importance value than of blocked streets. In some exemplary embodiments, a processor on a computer may be used in order to translate the natural language of the description of the event report to data that can be used to calculate the importance value. In other exemplary embodiments, a human can interpret the description of the event report in order to feed data to a processor on a computer that calculates the importance value for the event. In some exemplary embodiments, there is provided a pre-defined set of categories for events that are reported. In other exemplary embodiments, there is provided a pre-defined set of categories of sues that can or will be handled by an operations entity. In some exemplary embodiments, the importance of the event is determined as either high or low, and the importance value is set accordingly. In some exemplary embodiments the importance value is set based on the category in which the event is categorized.

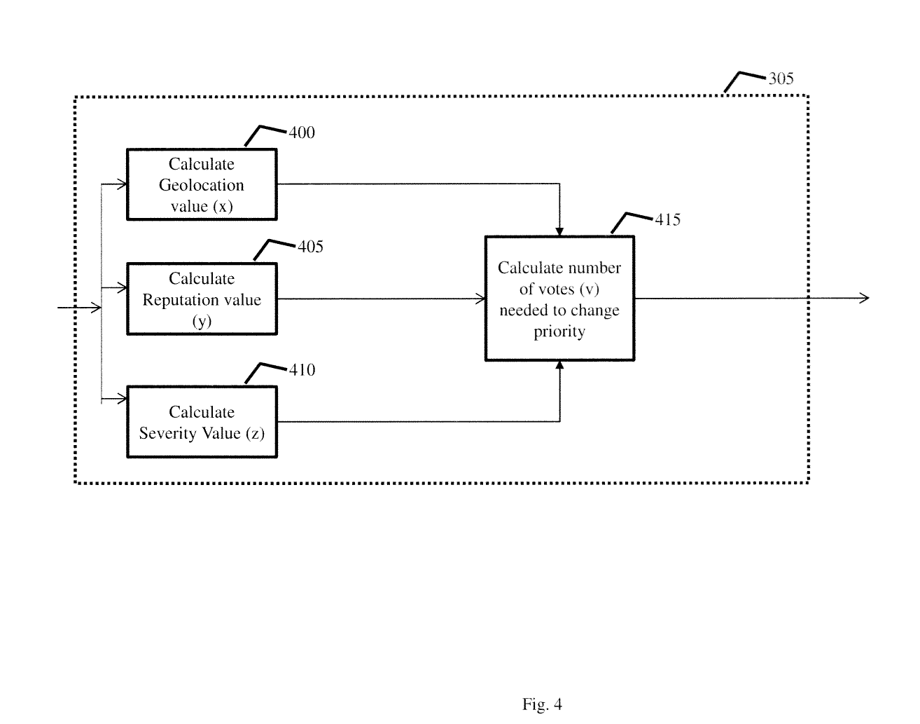

FIG. 4 depicts a system block diagram of an exemplary embodiment, which determines the minimum number of votes 305 needed in order to change the priority of the event 220. Like parts to those discussed above are designated with like reference numbers, and therefore a duplicative discussion will not be provided. According to the reporting information 200, a geolocation value 400 of the reporting entity is calculated. The geolocation value 400 is determined based on the geolocation information of the reporting entity 200 discussed above. In some exemplary embodiments, the closer the reporting entity is located to the event, the more weight their geolocation value 400 is given.

A reputation value 405 of the reporting entity is also calculated. As discussed above, the reputation value 405 of the reporting entity may be based on votes received for previously reported events. In some exemplary embodiments, the reputation value can be based on the occupation of the reporting entity, as well as, the votes received for previously reported events.

An importance value 410 may be calculated based on the description of the event. The description of the event may be determined from of a picture of the event, a video of the event, a video describing the event, an electronic message, e.g., an e-mail message, a text message, etc., or any combination thereof. If the description falls into a predefined category, then the description will receive the importance value associated with that predefined category. In some exemplary embodiments, data mining techniques may be used to calculate an importance score on the basis of the words in the description, the elements present in a picture, a number of people affected, etc.

Based on the geolocation value 400, the reputation value 405, and the importance value 410, the number of votes 415 needed to change a priority of an event is calculated. In other words, the event is assigned a minimum number of votes that are needed to change the priority of the event.

The number of votes calculated 415 and the number of votes received are then compared with each other in order to prioritize the event 220.

In some exemplary embodiments, the number of votes (v) needed in order to change the priority of the event is determined based on the following formula, where x=geolocation value 400, y=the reputation value 405, and z=the importance value 410:

v=x+y+z

In some exemplary embodiments, the each of the values can initially be configured with a certain weight, which can be refined over time. For example, the respective weights can be refined based on historical data.

In some exemplary embodiments, at least one of the geolocation value (x), the reputation value (y), and the importance value (z) is weighted differently than the other values. Each of the values may also have a unique weight respective to the weight of the other values.

In some exemplary embodiments, the values may be multiplied together rather than added. In this case, if one or more values equals zero, then the values that equal zero are not factored into the calculation. For example, if the geolocation value (x) equals five (5), the reputation value (y) equals zero (0), the importance value (z) equals three (3), and the module executing 415 of FIG. 4 is configured to multiply the values, then the module executing 415 will not consider the reputation value (y) (or will use a default value of one) and will calculate the number of votes needed to change the priority to be fifteen (15) (e.g., v=x*z).

In still another exemplary embodiment, two values may be multiplied together and the other value may divide the multiplied values, be added to the multiplied values, or be divided by the multiplied values. E.g., v=x*y/z; v=x*y+z; v=z/(x*y), respectively.

In some exemplary embodiments, a plurality of formulas may be used in order to calculate the number of votes (v). If one of those formulas returns the number zero would result in a divide by zero, then er one of those formulas will be used.

As would be understood by one having ordinary skill in the art having read the instant specification, the calculation of the number of votes needed in order to change the priority of the event may be determined according to other exemplary combinations of the values (x, y, z), all of which are contemplated herein.

In order to prioritize the event, the number of votes (v) calculated 415 and the number of votes received 210 are compared with each other.

In some exemplary embodiments, the importance value is set based on a binary determination of the importance (e.g., high importance or low importance). Similarly, the geolocation value can also be based on a binary determination of whether the location of the reporting entity is within a predetermined threshold distance of the event (e.g., within predetermined threshold or not within predetermined threshold). Likewise, the reputation value can also be based on a binary determination of whether the reporting entity has a high reputation or a low reputation (e.g., within predetermined threshold or not within predetermined threshold).

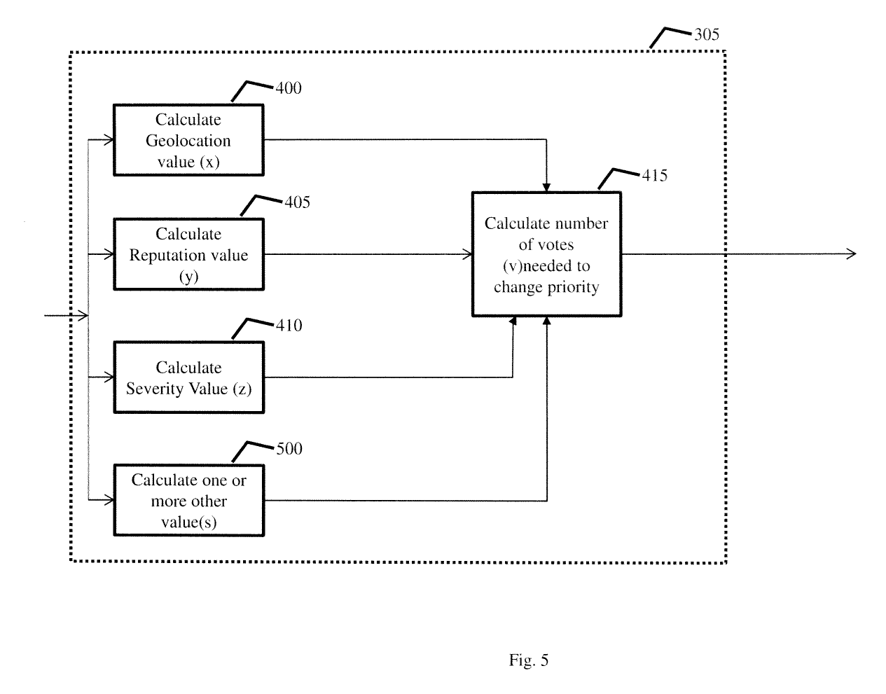

FIG. 5 depicts a system block diagram of an exemplary embodiment, which determines the minimum number of votes 305 needed in order to change the priority of the event 220. Like parts to those discussed above are designated with like reference numbers, and therefore a duplicative discussion will not be provided. One or more other values 500 may be calculated based on the received information 200. In some exemplary embodiments, the one or more other values 500 may be included into any of the above mentioned exemplary schemes for calculating 415 the minimum number of votes 305 needed to change the priority of the event.

For example, the time that the report information is received can be another value that is used to calculate 415 the minimum number of votes 305 that are needed in order to change the priority of the event. For example, if the report information 200 is received at a time that is within a peak time period, then the minimum number of votes 305 needed to change the priority may be greater than if the is not within the peak time period.

The presence of information that strengthens, confirms, corroborates, supports, etc., the report of the reporting entity may reduce the minimum number of votes 305 that are required to change the priority of the event. Likewise, the presence of information that contradicts, rebuts, invalidates, etc. the report of the reporting entity may increase the minimum number of votes 305 that are needed to change the priority of the event. Therefore, in some exemplary embodiments, whether the reporting entity has provided supporting information (e.g., by way of non-limiting examples, a picture of the event, a video of the event, information from a sensor that helps to corroborate the reporting entities report, etc.) can also be another factor in calculated the number of votes (v) needed. If, for example, the reporting entity provides some form of supporting information, then the number of votes required may be less than if the reporting entity does not provide supporting information.

Similarly, in some exemplary embodiments, if more than one reporting entity reports an event, then the number of votes may be less than if only one reporting entity reports the event. Similarly, the more reporting entities that report the event, the lower the number of votes that are needed to change the priority of the event.

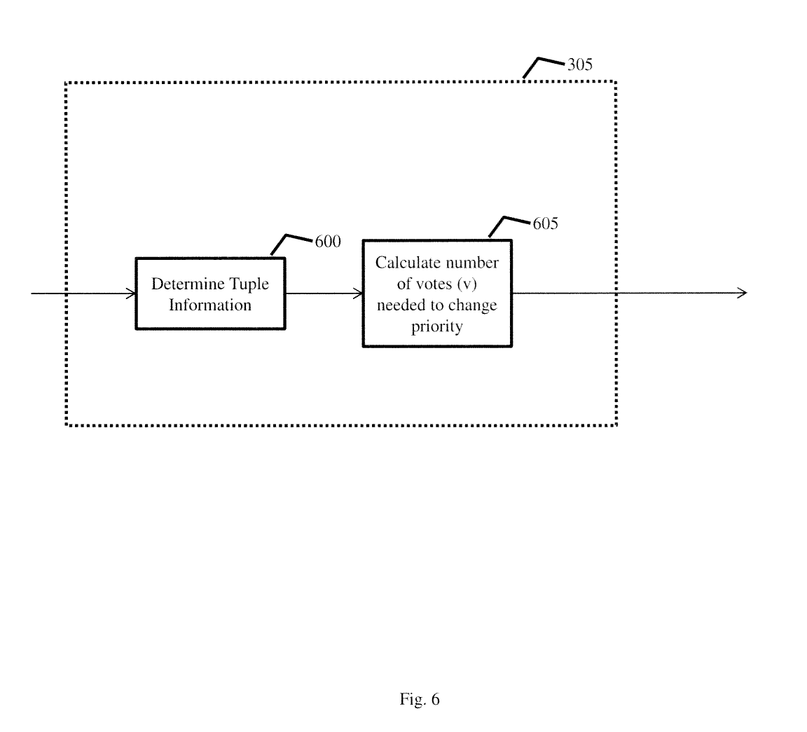

FIG. 6 depicts a system block diagram of an exemplary embodiment, which determines the minimum number of votes 305 needed in order to change the priority of the event 220. In some exemplary embodiments, the minimum number of votes needed in order to change the priority of the event is determined by a plurality of tuples. Tuples are a list of configurable parameters used by the systems, methods, and computer program products disclosed herein in order to determine the minimum number of votes required to change the priority of the event according to the report information. Each of the tuples includes a parameter (n) and a function (f).

Tuple information 600 includes the number of tuples (N), and the respective parameter (n) and function (f) of each tuple. The plurality of tuples may include any one or more of: the geolocation of the reporting entity; the reputation of the reporting entity; the importance of the event; supporting information; the time at which the reporting entity reported the event; a nber of entities who are available to respond to the event; a number of reporting entities reporting the event; the amount of time that the event has been reported and unaddressed; etc.

The minimum number of votes 305 needed in order to change the priority of the response is calculated 605. Similar to the discussion above, the following is one exemplary formula for calculating the minimum number of votes (v):

v=Σᵢ₌₁^{i=N}fᵢ(nᵢ)

A processor in a computer system can be used in order to perform the aforementioned calculation.

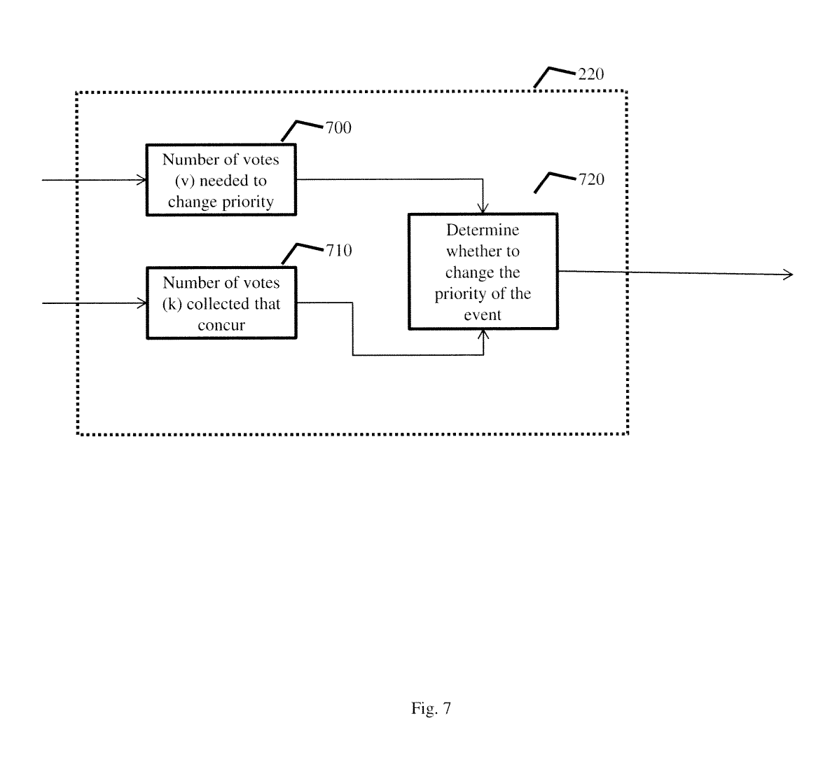

FIG. 7 depicts a system block diagram of an exemplary embodiment, which prioritizes the event 220. Like parts to those discussed above are designated with like reference numbers, and therefore a duplicative discussion will not be provided. In some exemplary embodiments, e.g., FIG. 2, the minimum number of votes needed to change the priority is calculated 700 (e.g., from the report information received at block 200). In other exemplary embodiments, e.g., FIG. 3, 4, 5, or 6, the minimum number of votes 305 needed to change the priority of the event is transferred.

A number of collected votes 710, which concur with the report event, is ascertained from the vote information 210. For example, in if fifteen voting entities each cast a concurring vote, then the number of votes collected 710 would be fifteen.

In some exemplary embodiments, the reputation of the voter casting a vote (kᵢ) is considered. That is, the value of the vote of each voter can be dynamically associated with the reputation of the voter. For example, if the voter has a low reputation, then their vote may have a value that is less than that of a voter having a high reputation. More specifically, the vote of a voter with a low reputation may be considered to be one-half of one vote, the vote of a voter with a neutral reputation may be considered to be one vote, and the vote of a voter with a high reputation may be considered to be one and a half votes. Based on this example, five voting entities cast a concurring vote (one having a low reputation, one having a normal reputation, and three having a high reputation), then the number of concurring votes would be six. The above is merely provided as an example and other dynamic association schemes are contemplated herein.

Based on the above, it will be appreciated that every event can be assigned a minimum number of votes (v) for which a priority of the event will be changed, that the number of collected votes (k) can be monitored, and that the number of collected votes (k) can be dynamically adjusted to account for the reputation of the voters. According to the number of collected votes (k), the event is assigned to one of a plurality of prioritization categories.

By way of non-limiting example, the plurality of prioritization categories can include an urgent prioritization, a normal prioritization, and a relaxed prioritization. In this example, if the number of collected votes (k) is greater than or equal to the minimum number of votes (v), then the event will be prioritized as urgent. If the number of collected votes (k) is less than the minimum number of votes (v) and greater than or equal to (v/2), then the event will be prioritized as normal. Otherwise, if the number of collected votes (k) is less than the minimum number of votes divided by two (v/2), then the event will be prioritized as relaxed.

Although three categories are used in the above example of prioritization, any alternative scheme to define prioritization categories could be used. In this way, the threshold (number of votes) to the intermediary categories can be defined accordingly. One having ordinary skill in the art and having read the instant specification will appreciate that exemplary embodiments having more than three prioritization categories, as well as, exemplary embodiments having less than three prioritization categories are contemplated herein. Similarly, it will be appreciated that other formulas may be used in order to separate the various prioritization categories and that the exemplary embodiment provided above is not limiting.

In some exemplary embodiments, if the event falls within a certain category, then the event can be prioritized based on the certain category regardless of whether the minimum number of votes (v) has been received. For example, if the reporting entity reports a violent felony, a fire, etc., then the event can be prioritized as an urgent event without requiring the collected votes (k) to equal or exceed the minimum number of votes (v).

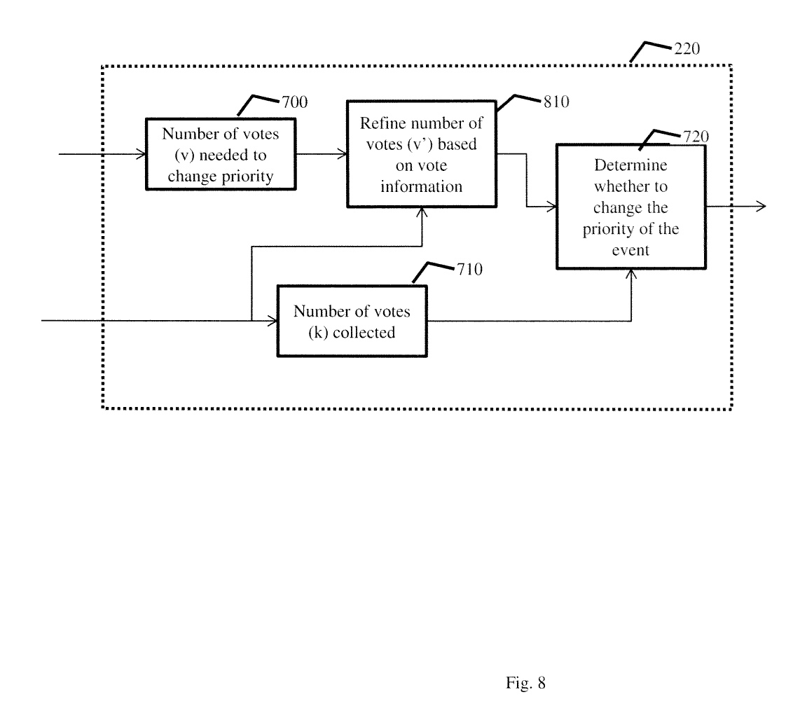

FIG. 8 depicts a system block diagram of an exemplary embodiment, which prioritizes the event 220. Like parts to those discussed above are designated with like reference numbers, and therefore a duplicative discussion will not be provided. In this exemplary embodiment, the minimum number of votes (v) 700 required to change the priority of the event to urgent is computed based on the reporting information of the reporting entity. Based on the number of voting information 210 and the minimum number of votes 700 needed to change the priority of the event, a refined minimum number of votes (v′) 810 is calculated. That is, a refined minimum number of votes (v′) 810 is calculated based on the geolocation and reputation of the respective voters and the minimum number of votes (v).

In some exemplary embodiments, the refined minimum number of votes (v′) required to change the priority of the event may be based on the geolocation and reputation of each voter respectively (e.g., v₁, v₂, . . . vₙ). The average of each of the number of votes (e.g., v₁, v₂, . . . vₙ) and the minimum number of votes (v) 700 is calculated. This average is set as the refined minimum number of votes (v′) 810 needed to change the priority of the event.

In some exemplary embodiments, the median (rather than the average) is selected as the refined minimum number 810. As would be appreciated, one having ordinary skill in the art and who has read the instance specification would understand that any statistical measurement can be applied to the numbers associated with (e.g., v₁, v₂, . . . vₙ and v) order to calculate or set the minimum number of votes (v′).

As will be appreciated by one skilled in the art, aspects of the present invention may be embodied as a system, method or computer program product. Accordingly, aspects of the present invention may take the form of an entirely hardware embodiment, an entirely software embodiment (including ware, resident software, micro-code, etc.) or an embodiment combining ware and hardware aspects that may all generally be referred to herein as a “circuit”, “module” or “system.” Furthermore, aspects of the present invention may take the form of a computer program product embodied in one or more computer readable medium(s) having computer readable program code embodied thereon.

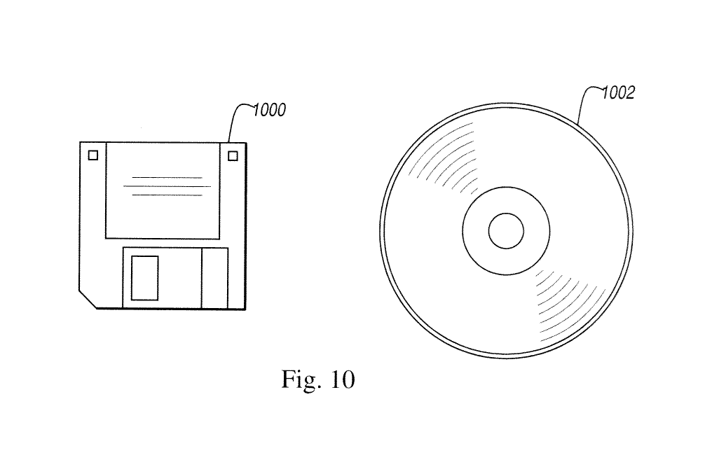

Any combination of one or more computer readable medium(s) may be utilized. The computer readable medium may be a computer readable signal medium or a computer readable storage medium. FIG. 10 shows some exemplary computer readable storage mediums. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc. or any suitable combination of the foregoing.

Computer program code for carrying out operations for aspects present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or system. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

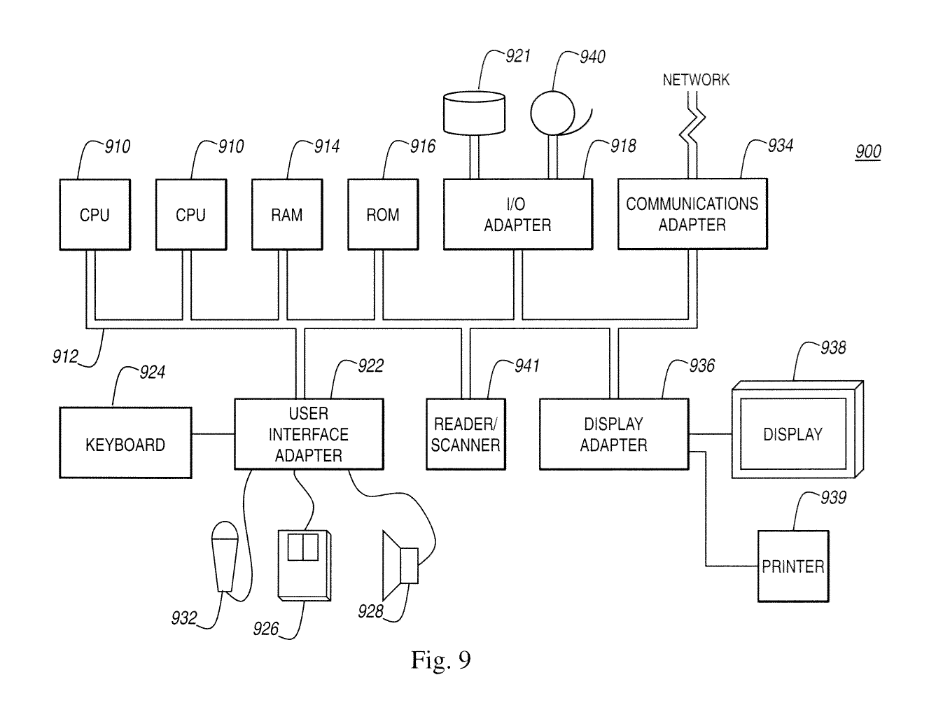

FIG. 9 shows a typical hardware configuration 900, which may be used for implementing the aforementioned inventive aspects of the present disclosure. The configuration has preferably at least one processor or central processing unit (CPU) 910. The CPUs 910 are interconnected via a system bus 912 to a random access memory (RAM) 914, read-only memory (ROM) 916, input/output (I/O) adapter 918 (for connecting peripheral devices such as disk units 921 and tape drives 940 to the bus 912), user interface adapter 922 (for connecting a keyboard 924, mouse 926, speaker 928, microphone 932, and/or other user interface device to the bus 912), a communication adapter 934 for connecting an information handling system to a data processing network, the Internet, an Intranet, a personal area network (PAN), etc., and a display adapter 936 for connecting the bus 912 to a display device 938 and/or printer 939. Further, an automated reader/scanner 941 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of storage media.

Thus, this aspect of the present invention is directed to a programmed product, including storage media tangibly embodying a program of machine-readable instructions executable by a digital data processor to perform the above method.

Such a method may be implemented, for example, by operating the CPU 910 to execute a sequence of machine-readable instructions. These instructions may reside in various types of storage media.

Thus, this aspect of the present invention is directed to a programmed product, including storage media tangibly embodying a program of machine-readable instructions executable by a digital data processor incorporating the CPU 910 and hardware above, to perform the method of the invention.

This non-transitory storage media may include, for example, a RAM contained within the CPU 910, as represented by the fast-access storage for example. Alternatively, the instructions may be contained in another storage media, such as a magnetic data storage diskette 1000 or compact disc 1002 (FIG. 10), directly or indirectly accessible by the CPU 910.

Whether contained in the computer system/CPU 910, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable storage media. In an illustrative embodiment of the invention, the machine-readable instructions may comprise software object code, compiled from a language such as C, C⁺⁺, etc.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

With its unique and novel features, the exemplary aspects of the present disclosure may provide systems, methods, and computer program products, which rank information under in order to prioritize responses to speed the resolution of a problem. Furthermore, exemplary aspects of unique and novel features of the present disclosure may provide systems, methods, and computer program products, which optimize the deployment of personnel in order to more efficiently and quickly respond to an incident. Even more, exemplary aspects of unique and novel features of the present invention may provide systems, methods, and computer program products, which determine what services and infrastructure should be tended to first in order to address the issues of the population.

While the invention has been described in terms of several exemplary embodiments, those skilled in the art will recognize that the invention can be practiced with modification within the spirit and scope of the described embodiments and the appended claims.

Further, it is noted that, Applicant's intent is to encompass equivalents of all claim elements, even if amended later during prosecution.

What is claimed is:

1. A method of prioritizing information, the method comprising:
receiving report information of an event, the report information including geographical identifying information of a reporting entity;
one of receiving or determining vote information in response to the report information; and
prioritizing the event according to the report information and the vote information, as performed by a processor in a computer system.

2. The method according to claim 1, further comprising calculating a number of votes needed to change a priority of the event according to information that defines at least one characteristic of the reporting entity.

3. The method according to claim 2, further comprising refining the number of votes needed to change the priority of the event according to information that defines at least one characteristic of a voting entity which generated the vote information.

4. The method according to claim 3, wherein the information that defines at least one characteristic of the voting entity includes a geolocation of the voting entity.

5. The method according to claim 1, wherein the prioritizing comprises:
calculating a number of votes that is needed in order to change a priority of the event; and
changing the priority of the event, if the vote information includes a number of collected votes that is greater than or equal to the calculated number of votes.

6. A method of prioritizing an event, the method comprising:
receiving a report of the event from a reporting entity, the report including geographical information of the reporting entity and information relating to the event;
determining a certain number of votes needed to change an initial priority of the event according to the report, the determining being performed by a processor in a computer system; and
changing the initial priority of the event, if the certain number of votes is received.

7. The method according to claim 6, further comprising:
determining a reputation of the reporting entity; and
changing the certain number of votes according to the reputation of the reporting entity.

8. The method according to claim 6, further comprising:
receiving a vote from each of a plurality of voting entities;
determining a reputation of a voting entity of the plurality of voting entities according to historical voting information of the voting entity; and
adjusting a weight of the vote of the voting entity according to the reputation of the voting entity.

9. The method according to claim 6, further comprising:
determining a category of the event based on the reporting information; and
changing the initial priority of the event if the category of the event comprises a certain category.

10. The method according to claim 6, wherein the information relating to the event comprises at least one of:
a photograph related to the event;
a video related to the event; and
text describing the event.

11. A method of prioritizing a response to an event, the method comprising:
receiving a report regarding the event;
determining a value of a vote for the report that is associated with the event; and
prioritizing, as performed by a processor in a computer system, the response to the event, based on values calculated for each parameter of a plurality of tuple parameters, the tuple parameters including at least one of:
a distance between a reported location of the event and a location of an entity that reports the event; and
a distance between the reported location of the event and a location of an entity that transmits the vote associated with the event.

12. The method according to claim 11, wherein the plurality of tuple parameters further include a value representing a reputation of the entity making an event report.

13. The method according to claim 11, wherein the plurality of tuple parameters further include a value representing a reputation of an entity that casts a vote associated with the event.

14. The method according to claim 11, wherein the plurality of tuple parameters further include a value representing a time of the report relative to the time of the event.

15. The method according to claim 11, further comprising determining a minimum number of votes needed in order to change a priority of the event according to information including at least one of:
one or more characteristics of the reporting entity; and
a prioritization category that is assigned to the event according to information included in the report.

16. A method of prioritizing a plurality of events, the method comprising:
gathering information relating to each event of the plurality of events;
determining crowdsourced information relating to each event, the crowdsourced information of each event including vote information associated with each voting entity of a plurality of voting entities, the vote information of each voting entity including at least one of:
a first geolocation value, which is based on comparing a reported location of the event and a location of a voting entity having generated the vote information; and
a first reputation value associated with the voting entity having generated the vote information; and
determining, as performed by a processor in a computer system, an order in which to respond to the plurality of events according to a plurality of factors including tuple information expressing at least one of the first geolocation value and the first reputation value.

17. The method according to claim 16, wherein the information relating to each event further includes:
a second geolocation value, which is based on comparing the reported location of the event and a location of a reporting entity having reported the event; and
a second reputation value associated with the reporting entity having reported the event, and
wherein the tuple information further expresses the second geolocation value and the second reputation value.

18. The method according to claim 17, further comprising determining, according to the tuple information, a minimum number of votes needed to change a priority of the event,
wherein the vote information of each voting entity further includes a vote indicating whether the voting entity reports a value that would suggest changing the priority of the event.

19. The method according to claim 16, wherein the plurality of factors for determining the order in which to respond to the plurality of events further includes whether a category of the event being prioritized includes a certain category, and wherein:
if the category of the event being prioritized includes the certain category, then the event is prioritized according to the certain category, and
if the category of the event being prioritized does not include the certain category, then the event is prioritized according to the tuple information.

20. A computer program product tangibility embodying a program of machine-readable instructions executable by a digital processing apparatus to perform an event prioritization method, the method comprising:
determining geographical identifying information of a reporting entity having transmitted report information of an event;
aggregating vote information associated with the report information; and
prioritizing the event according to a plurality of factors including:
the report information;
the vote information; and
the geographical identifying information of the reporting entity.

21. The computer program product according to claim 20, wherein the method further comprises calculating a number of votes needed to change a priority of the event according to a tuple that defines a characteristic of the reporting entity.

22. The computer program product according to claim 21, wherein the method further comprises refining a number of votes needed to change the priority of the event according to a value of a tuple that defines a characteristic of a voting entity that generated the vote information.

23. The computer program product according to claim 22, wherein the characteristic of the voting entity includes a geolocation of the voting entity.

24. The computer program product according to claim 20, wherein the prioritizing comprises:
calculating a number of votes that are needed in order to change a priority of the event; and
changing the priority of the event if the vote information includes a number of collected votes that is greater than or equal to the calculated number of votes.

25. The computer program product according to claim 21, wherein the characteristic of the reporting entity includes a value representing a reputation of the reporting entity.
